(19) United States
(12) Patent Application Publication
(10) Pub. No.: US 2023/0182604 A1
(43) Pub. Date: Jun. 15, 2023

(54) DC-TO-DC CONVERTER DEVICE AND CONTROL/REGULATING SYSTEM FOR A POWER GRID

(71) Applicants: Richter R & W - Steuerungstechnik GmbH, Ahorntal (DE); Fraunhofer-Gesellschaft zur Förderungder angewandten Forschung e.V., München (DE)

(72) Inventors: Bernd ZEILMANN, Ahorntal (DE); Bernd WUNDER, Forchheim (DE)

(21) Appl. No.: 17/917,609

(22) PCT Filed: Mar. 19, 2021
(86) PCT No.: PCT/EP2021/057137

§ 371 Date: Oct. 7, 2022

(30) Foreign Application Priority Data
Apr. 9, 2020 (DE) 10 2020 204 625.5

(51) Int. Cl. B60L 53/63; H02J 7/00; H02J 7/02; H02M 3/00; G05B 19/042; B60L 53/16

(52) U.S. Cl. CPC B60L 53/63; H02J 7/0013; H02J 7/0045; H02J 7/02; H02M 3/003; G05B 19/042; B60L 53/16; H02J 2207/20; G05B 2219/2639; B60L 2210/30; B60L 2210/10

(57) ABSTRACT

A DC/DC converter device has a DC/DC converter with a defined voltage conversion ratio which does not equal 1. A switch assembly is used to switch a current flow between a converter input node and a converter out-put node of the DC/DC converter. In a first switch position, the DC/DC converter is operated in a first current flow direction, and in a second switch position, the DC/DC converter is operated in a second, opposite current flow direction. An electric charge connection unit is used for DC charging process of batteries of mobile loads via multiple socket/plug connections. A galvanic isolation element is used to galvanically isolate of the socket/plug connections. The DC/DC converter device can be part of a control/regulating system for a power grid. The result is a DC/DC converter device with which the possibility of a DC charging process for batteries of mobile loads is improved.

### CROSS-REFERENCES TO RELATED APPLICATIONS

This application claims the priority of German Patent Application, Ser. No. 10 2020 204 625.5, filed Apr. 9, 2020, the content of which is incorporated herein by reference in its entirety as if fully set forth herein.

### FIELD OF THE INVENTION

The invention relates to a DC/DC converter device. Further, the invention relates to a control/regulating system for a power grid having an AC system level and a DC system level which comprises a DC/DC converter device of this type.

### BACKGROUND OF THE INVENTION

DE 10 2018 111 154 Al discloses a charging system having at least one DC power connection and at least one AC power connection. DE 10 2018 215 777 A1 discloses a control/regulating module for a modular control/regulating system for a power grid.

### SUMMARY OF THE INVENTION

It is an object of the present invention to improve the possibility of a DC charging process for batteries of mobile loads.

This object is achieved according to the invention by a DC/DC converter device
having a DC/DC converter with a defined voltage conversion ratio which does not equal 1,
having a switch assembly to switch a current flow between a converter input node and a converter output node of the DC/DC converter, wherein the switch assembly is switchable such that
   in a first switch position of the switch assembly, the DC/DC converter is operated in a first current flow direction, and
   in a second switch position of the switch assembly, the DC/DC converter is operated in a second current flow direction which is opposite to the first current flow direction,
having an electric charge connection unit for a DC charging process of batteries of mobile loads via multiple socket/plug connections,
having a galvanic isolation element to galvanically isolate the socket/plug connections.

According to the invention, it has been recognized that a switch assembly with switch positions in which the DC/DC converter of the DC/DC converter device can be operated in mutually opposite current flow directions enables a very flexible presetting of a DC charge voltage in an enlarged range. The defined voltage conversion ratio of the converter, which does not equal 1, can be used both directly and, with the current flow direction reversed, reciprocally. Different voltage ranges can then be covered via such a pole reversal, so that correspondingly different charging system requirements of the mobile loads can be met. Charge voltages, for example, of 800 V, of 400 V or even lower charge voltages can be made available via one and the same electric charge connection unit. In particular, it is not necessary to provide a DC/DC converter with variable voltage conversion ratio, so robust DC/DC converters with fixed voltage conversion ratio can be used. The galvanic isolation element allows multiple mobile loads to be connected to the DC/DC converter device while complying with safety regulations. In addition, the DC/DC converter device can be equipped with a grid regulating device that provides a DC input voltage selectable in a range at the converter input node. The DC voltage range provided by the grid regulating device may be between 110 V and 500 V, for example between 180 V and 400 V, DC. The DC/DC converter device and/or the galvanic isolation element may be designed for bidirectional use as a whole, so that charging current can be delivered to or alternatively fed from batteries of mobile loads via the charge connection unit.

As mobile loads, e-vehicles in the form of passenger cars or also in the form of commercial vehicles such as forklifts or high loaders as well as other mobile loads can be charged or can be used as energy sources and feed back stored battery power to a DC grid via the DC/DC converter device.

The electric charge connection unit can be designed as a CCS plug-and-charge unit.

A switch assembly having a further switch position for bridging the

DC/DC converter, in which the switch assembly is switchable such that, in a further switch position of the switch assembly, the DC/DC converter is bridged between the converter input node and the converter output node, additionally makes the converter device more flexible, since a voltage conversion ratio which equals 1 is then provided in a simple manner

An embodiment of the switch assembly having at least four switches, has been proven in practice. The switch assembly may have a total of four or six switches. The switches may be configured as contactor switches, in particular mechanical, magnetic contactors or electronic switches.

Controlling the switches so that they can be opened and closed in pairs, provides a simplified control solution.

A DC/DC converter having a fixed voltage conversion ratio in the range between 1:1.1 and 1:10 enables conversion ratios that are relevant in practice. The voltage conversion ratio may be between 1:1.5 and 1:5, between 1:2 and 1:4, depending on the embodiment of the DC/DC converter, and maybe, for example, 1:2, 1:2.5, or 1:3.

The advantages of a control/regulating system for a power grid
having an AC system level with an inverter and a connection to a public AC grid,
having a DC system level comprising the DC/DC converter device according to the invention
   correspond to those already explained above with reference to the DC/DC converter device according to the invention. The control/regulating system may comprise a plurality of such DC/DC converter devices, for example, two, three, four, five, six, eight, ten or even more DC/DC converter devices of this type and/or a corresponding number of electric charge connection units and/or a corresponding number of galvanic isolation elements.

The advantages of a control/regulating system with a grid regulating device, in which the DC system level comprises a grid regulating device for presetting a DC voltage in a DC grid of the DC system level, have already been explained above. Such a grid regulating device can also be part of the DC/DC converter device. Insofar as several DC/DC converters are used, each of the DC/DC converters may be assigned its own grid regulating device.

A control/regulating system comprising a bidirectionally usable inverter of the AC system level (40) enables power to be retrieved from an AC grid on the one hand and power to be fed back to an AC grid on the other hand

In principle, the control/regulating system can also operate in a system independent of the public grid, i.e. it is capable of forming an island grid.

An embodiment example of the invention is explained in more detail below with reference to the drawing

### BRIEF DESCRIPTION OF THE DRAWING

FIG. 1 in a schematic block diagram shows a DC/DC converter device together with further connection components of a control/regulating system for a power grid;

FIG. 2 shows the entire control/regulating system including the DC/DC converter device of FIG. 1; and

FIG. 3A and 3B show another embodiment of the connection components of a DC level of the control/regulating system with a total of six charge points or charge connection units and associated DC/DC converter devices with a further embodiment, compared to the embodiment according to FIG. 1, of a switch assembly for switching a current flow between a converter input node and a converter output node of a DC/DC converter of the DC/DC converter device.

### DESCRIPTION OF THE PREFERRED EMBODIMENT

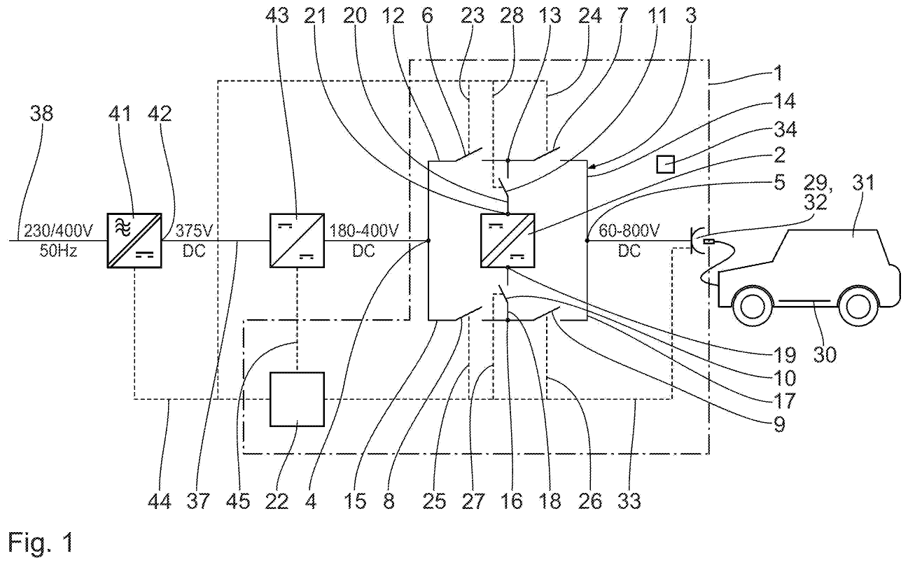

A DC/DC converter device 1, whose main components are enclosed by a dash-dotted line in FIG. 1, has a DC/DC converter 2. The DC/DC converter 2 has a defined voltage conversion ratio which does not equal 1. This voltage conversion ratio may range from 1:1.1 to 1:10, depending on the design of the DC/DC converter 2. Typical voltage conversion ratios are 1:2 or also 1:3. The following description assumes a fixed voltage conversion ratio of 1:2.

The DC/DC converter device 1 further includes a switch assembly 3 for switching a current flow between a converter input node 4 and a converter output node 5 of the DC/DC converter 2. This switch assembly 3 is switchable between different switch positions.

The switch assembly 3 has a total of six switch units in the form of contactor switches 6, 7, 8, 9, 10 and 11.

The first contactor switch 6 is arranged in a line section 12 between the converter input node 4 and a first connection node 13 of the DC/DC converter 2. The second contactor switch 7 is arranged in a further line section 14 between the first connection node 13 and the converter output node 5. The third contactor switch 8 is arranged in a further line section 15 between the converter input node 4 and a second connection node 16 of the DC/DC converter 2. The fourth contactor switch 9 is arranged in a further line section 17 between the second connection node 16 and the converter output node 5. The fifth contactor switch 10 is arranged in a further line section 18 between the second connection node 16 and a first connection port 19 of the DC/DC converter 2. The sixth contactor switch 11 of the switch assembly 3 is arranged in a further line section 20 between the first connection node 13 and a second connection port 21 of the DC/DC converter.

The switches 6 to 11 can be designed as mechanical contactors or as magnetic contactors or also as electronic switches.

A control of the switch units of the switch assembly 3, i.e. the contactor switches 6 to 11, is performed by a modular control unit 22 of the DC/DC converter device 1. Said modular control unit 22 is in signal connection with the contactor switches 6 to 11 for opening and closing the associated line sections 12, 14, 15, 17, 18 and 20 via the signal lines 23 to 28 shown dashed in the drawing.

The contactor switches 6 to 11 are controlled by the control unit 22 so that they can be opened and closed in pairs.

In a first switch position of the switch assembly 3, the contactor switches 6, 9, 10 and 11 are closed and the other contactor switches 7 and 8 are open. A current flow is thus possible between the converter input node 4 and the converter output node 5 via the line section 12, the closed contactor switch 6, the first connection node 13, the line section 20 via the closed contactor switch 11, the connection port 21, the DC/DC converter 2, the further connection port 19, the line section 18 via the closed contactor switch 10, the second connection node 16 and the line section 17 via the closed contactor switch 9. In this switch position in FIG. 1, the DC/DC converter 2 is operated from top to bottom and then has a voltage conversion ratio of 1:2. An input voltage of, for example, 400 V at the converter input node 4 is then converted via the DC/DC converter 2 into an output voltage of 800 V at the converter output node 5.

In a second switch position of the switch assembly 3, the DC/DC converter 2 is operated in an opposite current flow direction, i.e. in Fig. from bottom to top between the connection ports 19 and 21. In this second switch position, contactor switches 7, 8, 10 and 11 are closed and the other two contactor switches 6 and 9 are open. The current then flows between the converter input node 4 and the converter output node 5 via the line sections 15, 18, the DC/DC converter 2 between the connection ports 19 and 21, and via the line sections 20 and 14. In this second switch position, the DC/DC converter 2 then converts with a voltage conversion ratio of 2:1, so that the exemplary input voltage of 400 V at the converter input node 4 becomes an output voltage of 200 V at the converter output node 5.

The DC/DC converter device 1 further includes an electric charge connection unit 29 for a DC charging process of batteries 30 of loads 31 via a plurality of socket/plug connections 32, of which one connection is shown as an example in FIG. 1. As a load 31, a passenger car is exemplarily shown in FIG. 1.

The charge connection unit 29 is in signal connection with the control unit 22 via a further signal line 33. The control unit 22 is designed to receive information on a battery voltage of the battery 30 and on a maximum charge and discharge current suitable for the battery 30 via protocols DIN SPEC 70121 or ISO 15118 when the load 31 is plugged in via the socket/plug connection 32.

A galvanic isolation element 34, shown schematically in FIG. 1, is used to galvanically isolate the various socket/plug connections 33 of the charge connection unit 29.

The charge connection unit 29 may make use of a known charging standard, for example CCS.

In a further switch position of the switch assembly 3, the DC/DC converter 2 is bridged between the converter input node 4 and the converter output node 5. In this further switch position, a line connection between the converter input node 4 and the connection ports 19 and 21 and also between the converter output node 5 and the connection ports 19 and 21 is disconnected. A direct connection between the converter input node 4 and the converter output node 5 via the line sections 12, 14 and/or via the line sections 15 and 17 is provided in this further switch position for bridging the DC/DC converter 2. In this further switch position, for example, the contactor switches 6 and 7 are closed and the further contactor switches 8 to 11 are open. Contactor switches 8 and 9 can also be closed and the further contactor switches 6, 7, 10 and 11 can be open. In principle, apart from the open contactor switches 10 and 11, all further contactor switches 6 to 9 can also be closed in this further switch position. Other switch configurations are also possible in this further switch position, provided that it is ensured that the DC/DC converter 2 is bridged between the converter input node 4 and the converter output node 5, i.e. that there is no current flow between the connection ports 19 and 21.

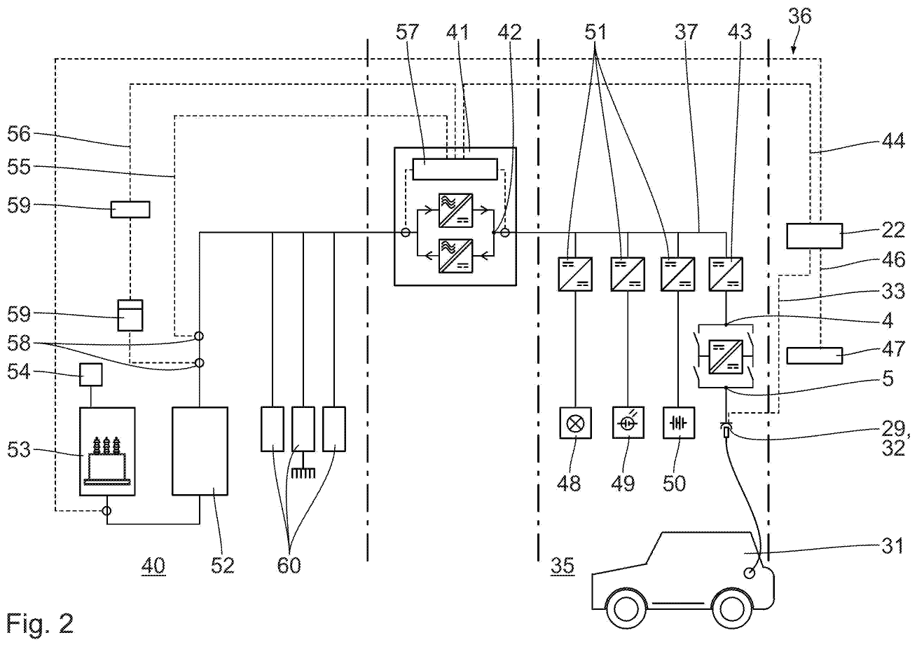

The DC/DC converter device 1 is part of a DC system level 35 of a control/regulating system 36 for a power grid, which includes a DC grid 37 and AC grid 38 (cf. FIG. 2).

An inverter 41 in the form of a balancing device is arranged between an AC system level 40 and the DC system level 35 in the control/regulating system 36. The inverter 41 is designed for bidirectional use, so that a current flow via the inverter 41 is possible on the one hand between the DC system level 35 and the AC system level 40 and on the other hand from the AC system level 40 into the DC system level 35.

A grid regulating device 43 is arranged between a DC converter node 42 of the inverter 41 and the converter input node 4 of the DC/DC converter 2. With said grid regulating device 43, a DC voltage present at the DC converter node 42 of the inverter 41 in the amount of 375 V, for example, can be regulated into a range between 180 V and 400 V DC and, in particular, continuously preset. The grid regulating device 43 can be part of the DC/DC converter device 1.

The inverter 41 and the grid regulating device 43 are in signal connection with the modular control unit 22 via further signal lines 44, 45. The signal line 44 can be a data bus, in particular a CAN bus. This applies accordingly to the further signal lines.

Via a data line 46 (cf. FIG. 2), the control unit 22 is in data connection with a server 47. The server 47 serves, on the one hand, for program control of the control/regulating system 36 and, on the other hand, for data monitoring/data analysis/data supply. For this purpose, the server 47 can, for example, also supply ambient and weather data via corresponding sensors and/or, for example, via Internet data.

Depending on the voltage requirement of the loads 31 connected via the socket/plug connections 32, a respective switch position of the switch assembly 3 can be preset via the control unit 22 and the necessary voltage conversion ratio as well as the necessary regulation ratio at the grid regulating device 43 can be set via this. Starting from a possible output voltage between the grid regulating device 43 and the converter input node 4 in the range between 180 V and 400 V DC, it is then possible to realize regional planning at the converter output node 5 in the range between 90 V and 800 V. Using a DC/DC converter 2 with a voltage conversion ratio of 1:3, a voltage range between 60 V and 1,200 V voltage can be realized at the converter output node 5 with the same voltage range at the converter input node 4. A wide variety of mobile supply units 31 with batteries 30 having different voltage requirements, in particular vehicles and working equipment, can then be charged automatically. This is done, after the appropriate switch position of the switch assembly 3 has been preset, by communication between the modular control unit 22 and a control unit of the load 31 communicating therewith.

Via the DC/DC converter device 1, a controlled discharge of the respective battery 30 of the load 31 via the charge connection unit 29 is also possible accordingly. A current flow is then reversed between the converter output node 5 and the converter input node 4 and then accordingly towards further loads of the DC system level 35 or via the inverter 41 towards the AC system level 40.

In the DC system level 35, further suppliers or loads can be connected to the DC grid 37, for example a lighting system 48, a photovoltaic system 49 or an energy storage system 50 in the form of a storage battery, for example. DC/DC or possibly also DC/AC converters 51 can be connected between these components 48 to 50 and the DC grid 37, as schematically indicated in FIG. 2.

The AC grid 38 is connected to a public AC grid 54 via a grid connection 52 and a transformer station 53. Via signal lines 55, 56, the AC grid 38 is in signal connection on the input side with a control unit 57 of the inverter 41. Via current measuring transducers 58 arranged in these signal lines 55, 56 and, if necessary, further measuring units 59, a phase symmetry at the grid connection 52 is monitored. The balancing device of the inverter 41 establishes a symmetry at the grid connection 52 via a current flow regulation by balancing a phase asymmetry which may have been detected.

The AC grid 38 is in turn connected to further loads 60.

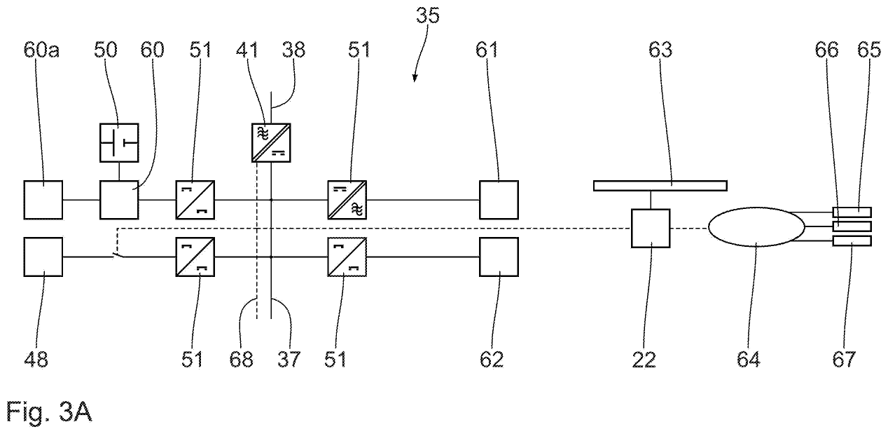

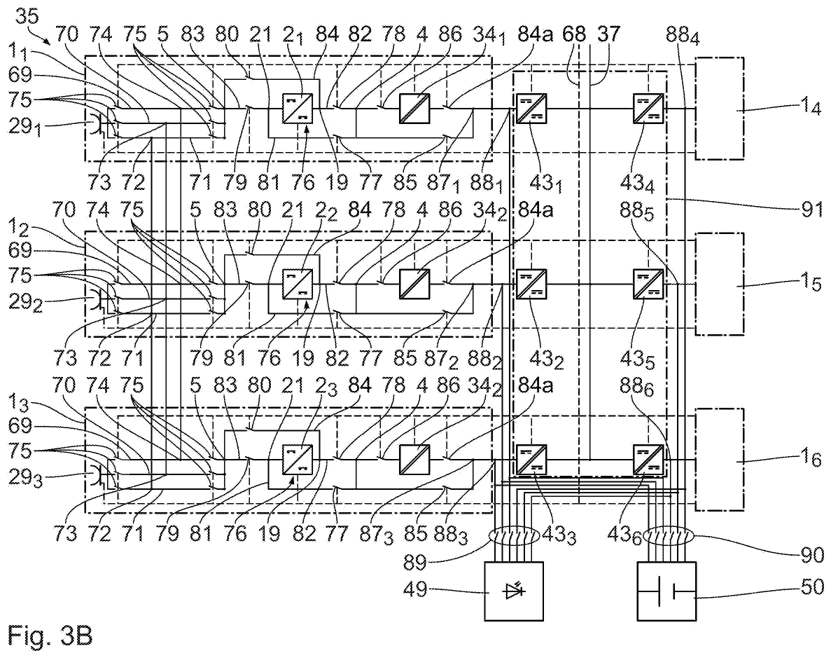

FIG. 3 (3A/B) shows a further embodiment of connection components for the DC system level 35 of the control/regulating system 36, which can be used as an alternative to DC grid-side connection components already explained above in connection with FIGS. 1 and 2. Components and functions corresponding to those already explained above with reference to FIGS. 1 and 2 bear the same reference numerals and will not be discussed in detail again.

FIG. 3 is divided into two subfigures 3A and 3B. FIG. 3A shows system components of the DC system level 35 that go beyond the DC/DC converter devices as well as the grid control devices. FIG. 3B shows a total of six DC/DC converter devices 1₁ to 1₆ with associated grid regulating devices 43i. The DC/DC converter devices 1₄ to 1₆, which otherwise correspond to the DC/DC converter devices 1₁ to 1₃, are shown in FIG. 3B only in a highly schematic manner The components shown in FIGS. 3A/B are interconnected via the DC grid 37.

The DC grid-side connection components are shown in FIG. 3 starting with the inverter 41, which is again designed as a balancing device.

The embodiment according to FIG. 3 has a total of six charge connection units 29₁ to 29₆ for a DC charging process, which are also referred to as charge points. The charge points 29₁ may in turn be CCS charge points. Since the charge points 29₁ are each constructed in the same way, it is sufficient to describe the charge point 29₁ below.

In addition to the charge points 29₁, an uninterruptible power supply (UPS) 60, a 230 V AC module 61 and a server 62 are shown as supply or load components in the embodiment according to FIG. 3, which in turn are connected to the DC grid 37 via DC/DC or DC/AC converters 51 (cf. FIG. 3A). The UPS 60 is in signal connection with a programmable logic controller (PLC) 62 for presetting, in particular, a control voltage. In addition, the UPS 60 is in communication with an energy storage device 60a. The energy storage device 60a may be designed as a battery.

In the embodiment according to FIG. 3, the modular control unit 22 is in signal connection with a smart meter gateway 63. Via this, the control unit 22 can be connected to various measuring units, via which information on load data, on status data of the control/regulating system 36, in particular of connection components of the DC grid 37, and also other external data, such as weather data, can be collected. Furthermore, the control unit 22 is connected to the Internet via a cloud 64, via which further data can be retrieved, for example vehicle data 65 on the respective vehicles connected to the charge point 29₁, weather data 66 and generally data from a weather station 67.

The modular control unit 22 is in signal connection with the DC grid-side components of the arrangement shown in FIG. 3 via a data bus 68 corresponding to the data bus 44.

The charge point 29₁ is conductively connected to the converter output node 5 of the associated DC/DC converter 21 via three alternatively usable line connections 69, 70, 71. Connection nodes 72, 73, 74 connect these line connections 69 to 71 with corresponding line connections 69, 71 of the charge points 29₂, 29₃. Via this and via connection contactor switches 75, the charge points 29₁, 29₂, 29₃ on the one hand and 29₄, 29₅, 29₆ on the other hand can be interconnected if required, for example if not all of these charge points are occupied and more charging power is to be made available to the individual occupied charge points 29₁.

A switch assembly 76 is used to switch a current flow between the converter input node 4 and the converter output node 5 of the DC/DC converter 21, which switch assembly 76 can be used instead of the switch assembly 3 explained above, in particular in connection with FIG. 1. The switch assembly 76 has a total of four contactor switches 77, 78, 79 and 80.

The contactor switch 77 is arranged in a line section 81 between the converter input node 4 and the connection port 21 of the DC/DC converter 21.

The contactor switch 78 is arranged in a line section 82 between the converter input node 4 and the further connection port 19 of the DC/DC converter 21. The contactor switch 79 is arranged in a line section 83 between the connection port 21 and the converter output node 5. The contactor switch 80 is arranged in a further line section 84 between the connection port 19 of the DC/DC converter 21 and the converter output node 5. By closing the switches 78 and 79 and opening the switches 77 and 80, the converter 21 is operated at a conversion ratio 2:1 between the connection ports 19 and 21. By closing the switches 77 and 80 with the switches 78 and 79 open, the converter 21 is operated in reverse current flow direction with a voltage conversion ratio 1:2 between the connection ports 21 and 19. Closing the switches 77, 79 when switches 78 and 80 are open bypasses the converter 21. This is also possible by closing the switches 78 and 80 when the switches 77 and/or 79 are open.

The switch assembly 76 has exactly four contactor switches, namely contactor switches 77 to 80.

The switches 77 to 80 as well as the other switches described above can also be designed as mechanical contactors or as magnetic contactors or as electronic switches.

The switch assembly 76 corresponds to the switch assembly 3 with regard to its function.

The associated galvanic isolation element or the associated galvanic isolation unit 34₁ is connected between the grid regulating device 43₁, which belongs to the charge point 29₁, and the converter input node 4, which belongs to the charge point 29₁. Further connection contactor switches 84a, 85, 86 allow a current flow between the grid regulating device 43₁ and the converter input node 4 through the galvanic isolation unit 34₁ or also bridging either only the galvanic isolation unit 34₁ between the grid regulating device 43₁ and the converter input node 4 or also completely bridging both the galvanic isolation unit 34₁ and the DC/DC converter 21 between a connection node 871, which is arranged between the grid regulating unit 43₁ and the galvanic isolation unit 34₁, and the output-side connection port 21 of the DC/DC converter 21. In this way, it is possible to conduct a current flow between the grid regulating device 43₁ and the converter output node 5 either via the galvanic isolation unit 34₁ and the DC/DC converter 2₁ or optionally via exactly one of these two components or optionally in such a way that both components 34₁ and 21 are bridged.

In the arrangement according to FIG. 3, each charge point 29₁ has an associated grid regulating unit 43i, so that there are a total of six grid regulating units 43₁ to 43₆. The same applies to the galvanic isolation units 34₁ to 34₆.

Direct feed-in of direct current to the respective charge points 29₁ to 29₆ is possible via the photovoltaic system 49 and the energy storage system 50. This is done via respective feed-in nodes 88ᵢ, which are arranged at the respective charge point 29₁ between the associated grid regulating device 43ᵢ and the respective connection node 87ᵢ. The photovoltaic system 49 and the energy storage system 50 can be selectively switched on and off via corresponding switches 89, 90 and can also be connected to each other for charging the energy storage system 50.

A bidirectional DC/DC converter can be used as a galvanic isolation unit 34ᵢ. An example of this is the “EZA 11 KW Series” converter from TDK-Lambda.

The grid regulating devices 43ᵢ are components of a grid regulating system 91, which is framed with dashed dots in FIG. 3.

1. A DC/DC converter device comprising:
a DC/DC converter with a defined voltage conversion ratio which does not equal 1;
a switch assembly to switch a current flow between a converter input node and a converter output node of the DC/DC converter, wherein the switch assembly is switchable such that in a first switch position of the switch assembly, DC/DC converter is operated in a first current flow direction, and in a second switch position of the switch assembly, the DC/DC converter is operated in a second current flow direction which is opposite to the first current flow direction;
an electric charge connection unit for a DC charging process of batteries of mobile loads via multiple socket/plug connections; and
a galvanic isolation element to galvanically isolate the socket/plug connections.

2. A DC/DC converter device according to claim 1, wherein the switch assembly is switchable such that, in a further switch position of the switch assembly, the DC/DC converter is bridged between the converter input node and the converter output node.

3. A DC/DC converter device according to claim 1, wherein the switch assembly has at least four switches.

4. A DC/DC converter device according to claim 3, wherein the switches are controllable so that they can be opened and closed in pairs.

5. A DC/DC converter device according to claim 1, wherein the DC/DC converter has a fixed voltage conversion ratio in the range between 1:1.1 and 1:10.

6. A control/regulating system for a power grid, the control/regulating system comprising:
an AC system level with an inverter and a connection to a public AC grid; and
a DC system level comprising: a DC/DC converter device, the DC/DC converter device comprising:
a DC/DC converter with a defined voltage conversion ratio which does not equal 1;
a switch assembly to switch a current flow between a converter input node and a converter output node of the DC/DC converter, wherein the switch assembly is switchable such that in a first switch position of the switch assembly, the DC/DC converter is operated in a first current flow direction, and in a second switch position of the switch assembly, the DC/DC converter is operated in a second current flow direction which is opposite to the first current flow direction;
an electric charge connection unit for a DC charging process of batteries of mobile loads via multiple socket/plug connections; and
a galvanic isolation element to galvanically isolate the socket/plug connections.

7. A control system according to claim 6, wherein the DC system level comprises a grid regulating device for presetting a DC voltage in a DC grid of the DC system level.

8. A control system according to claim 6, wherein the inverter of the AC system level is configured for bidirectional use.
